(19) United States
(12) Patent Application Publication
(10) Pub. No.: US 2010/0114930 A1
(43) Pub. Date: May 6, 2010

(54) SITUATION-AWARE, INTEREST BASED SEARCH QUERY GENERATION

(75) Inventors: Swaroop KALASAPUR, Santa Clara, CA (US); Doreen CHENG, San Jose, CA (US); Yu SONG, Pleasanton, CA (US); Sangoh JEONG, Palo Alto, CA (US)

Correspondence Address: Beyer Law Group LLP, P.O. BOX 1687, Cupertino, CA, 95015-1687, US

(73) Assignee: SAMSUNG ELECTRONICS CO., LTD, Suwon City (KR)

(21) Appl. No.: 12/266,273

(22) Filed: Nov. 6, 2008

(51) Int. Cl. G06F 17/30; G06F 15/16

(52) U.S. Cl. 707/759; 709/206; 707/E17.017

(57) ABSTRACT

A method for generating a portion of a query for a user is provided, the method comprising: retrieving information regarding the user's interests; and generating a portion of a query by analyzing the user's interests and the current situation of a user device operated by the user to determine at least one keyword.

### BACKGROUND OF THE INVENTION

1. Field of the Invention

The present invention relates to systems that take into account the interests and situations of users. More particularly, the present invention relates to search query generation based on user interest and situation.

2. Description of the Related Art

Conceptually, a computing system (e.g., a computing device, a personal computer, a laptop, a Smartphone, a mobile phone) can accept information (content or data) and manipulate it to obtain or determine a result based on a sequence of instructions (or a computer program) that effectively describes how to process the information. Typically, the information used by a computing system is stored in a computer readable memory using a digital or binary form. More complex computing systems can store content including the computer program itself. A computer program may be invariable and/or built into, for example a computer (or computing) device as logic circuitry provided on microprocessors or computer chips. Today, general purpose computers can have both kinds of programming. A computing system can also have a support system which, among other things, manages various resources (e.g., memory, peripheral devices) and services (e.g., basic functions such as opening files) and allows the resources to be shared among multiple programs. One such support system is generally known as an Operating System (OS) which provides programmers with an interface used to access these resources and services.

Today, numerous types of computing devices are available. These computing devices widely range with respect to size, cost, amount of storage and processing power, from the expensive and powerful servers, relatively cheaper Personal Computers (PC's) and laptops, to more inexpensive microprocessors or computer chips provided in storage devices, automobiles, and household electronic appliances.

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as handheld computer or simply handheld) can be a pocket-sized computing device, typically utilizing a small visual display screen for user output and a miniaturized keyboard for user input. In the case of a Personal Digital Assistant (PDA), the input and output can be combined into a touch-screen interface.

In particular, mobile communication devices (e.g., mobile phones) have become extremely popular. Some mobile communication devices (e.g., Smartphones) offer computing environments that are similar to that provided by a Personal Computer (PC). As such, a Smartphone can effectively provide a complete operating system as a standardized interface and platform for application developers. Given the popularity of mobile communication devices, telecommunication is discussed in greater detail below.

Generally, a mobile phone or cell phone can be a long-range, portable electronic device used for mobile communication. In addition to the standard voice function of a telephone, current mobile phones can support many additional services such as SMS for text messaging, email, packet switching for access to the Internet, and Multimedia Messaging Service (MMS) for sending and receiving photos and video. Most current mobile phones connect to a cellular network of base stations (cell sites), which is in turn interconnected to the public switched telephone network (PSTN) (one exception is satellite phones).

The Short Message Service (SMS), often called text messaging, is a means of sending short messages to and from mobile phones. SMS was originally defined as part of the GSM series of standards in 1985 as a means of sending messages of up to 160 characters, to and from Global System for Mobile communications (GSM) mobile handsets. Since then, support for the service has expanded to include alternative mobile standards such as ANSI CDMA networks and Digital AMPS, satellite and landline networks. Most SMS messages are mobile-to-mobile text messages, though the standard supports other types of broadcast messaging as well. The term SMS is frequently used in a non-technical sense to refer to the text messages themselves, particularly in non-English-speaking European countries where the GSM system is well-established.

Multimedia Messaging Service (MMS) is a relatively more modern standard for telephony messaging systems that allows sending messages that include multimedia objects (images, audio, video, rich text) and not just text as in Short Message Service (SMS). It can be deployed in cellular networks along with other messaging systems like SMS, Mobile Instant Messaging and Mobile E-mail. Its main standardization effort is done by 3GPP, 3GPP2 and Open Mobile Alliance (OMA).

There are circumstances where users of portable devices may be at a disadvantage as compared to similar users of desktop computers. One such example is where a system where a user is issuing queries to a server, such as when searching a database or querying a World Wide Web search engine. Users of portable devices may find such queries challenging to form, either because of the lack of a full keyboard and/or small screen size. What is needed is a solution that addresses these problems.

### SUMMARY OF THE INVENTION

In one embodiment, a method for generating a portion of a query for a user is provided, the method comprising: retrieving information regarding the user's interests; and generating a portion of a query by analyzing the user's interests and the current situation of a user device operated by the user to determine at least one keyword.

In another embodiment, a method for generating a portion of a query for a user is provided, the method comprising: automatically capturing user activity; analyzing the user activity to generate information regarding the user's interests and the situations under which the user expresses interest in the interests; constructing a context score for each of the situations; storing the information regarding the user's interests and the context scores associated with situations related to the interests in an interest store; deriving an interest related to a current situation by locating a situation in the interest store with a context score that is closest to a context score for the current situation; and generating a portion of a query using the derived interest.

In another embodiment, an apparatus is provided comprising: an interest store containing interests corresponding to a user and situations related to the interests; an interest-based query generator coupled to the interest store and configured to: retrieve information regarding user interests; and generate a portion of a query by analyzing the user's interests and the current situation of a user device operated by the user to determine at least one keyword corresponding to a user interest and the current situation of the user device.

In another embodiment, an apparatus is provided comprising: a user usage tracker configured to automatically capture user activity; a user interest manager configured to analyze the user activity to generate information regarding the user's interests and the situations under which the user expresses interest in the interests, construct a context score for each of the situations, and storing the information regarding the user's interests and the context scores associated with situations related to the interests in an interest store; and an interest-based query generator configured to derive an interest related to a current situation by locating a situation in the interest store with a context score that is closest to a context score for the current situation and generate a portion of a query using the derived interest.

In another embodiment, a system for generating a portion of a query for a user is provided, the system comprising: means for retrieving information regarding the user's interests; and means for generating a portion of a query by analyzing the user's interests and the current situation of a user device operated by the user to determine at least one keyword corresponding to a user interest and the current situation of the user device.

In another embodiment, a system for generating a portion of a query for a user is provided, the system comprising: means for automatically capturing user activity; means for analyzing the user activity to generate information regarding the user's interests and the situations under which the user expresses interest in the interests; means for constructing a context score for each of the situations; means for storing the information regarding the user's interests and the context scores associated with situations related to the interests in an interest store; means for deriving an interest related to a current situation by locating a situation in the interest store with a context score that is closest to a context score for the current situation; and means for generating a portion of a query using the derived interest.

In another embodiment, a program storage device readable by a machine tangibly embodying a program of instructions executable by the machine to perform a method for generating a portion of a query for a user is provided, the method comprising: retrieving information regarding the user's interests; and generating a portion of a query by analyzing the user's interests and the current situation of a user device operated by the user to determine at least one keyword corresponding to a user interest and the current situation of the user device.

In another embodiment, a program storage device readable by a machine tangibly embodying a program of instructions executable by the machine to perform a method for generating a portion of a query for a user is provided, the method comprising: automatically capturing user activity; analyzing the user activity to generate information regarding the user's interests and the situations under which the user expresses interest in the interests; constructing a context score for each of the situations; storing the information regarding the user's interests and the context scores associated with situations related to the interests in an interest store; deriving an interest related to a current situation by locating a situation in the interest store with a context score that is closest to a context score for the current situation; and generating a portion of a query using the derived interest.

### BRIEF DESCRIPTION OF THE DRAWINGS

FIG. 1 is a diagram illustrating an overview of an embodiment of the present invention.

FIG. 2 is a diagram illustrating the architecture of an embodiment of the present invention.

FIG. 3 shows an example of a distributed learning system on CE devices, examples of context collected via sensors, examples of software module distribution, and examples of use case scenarios.

FIG. 4 is a flow diagram illustrating a method for generating a portion of a query for a user in accordance with an embodiment of the present invention.

FIG. 5 is a flow diagram illustrating a method for generating a portion of a query for a user in accordance with another embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, personal devices used by a user, such as portable computers, participate in learning about user habits and interests. It should be noted that any device utilized by the user may participate in learning about user habits and interests, including, for example, phones, televisions, desktop computers, printers, robots, and cars.

In an embodiment of the present invention, each such device tracks user's usages of the device, along with context values associated with the usage. Examples of context variables include time, day, location, temperature, weather, co-locators, application being used, lighting, etc. If the device has sufficient computing and storage resources, it will use learning algorithms to extract situational user interest patterns from the log data. Otherwise, the device will send its log data to a device designated to extract interest patterns in its behalf. The patterns extracted on a single device may only capture user's interests in a small number of domains, e.g. TV for TV program related activities and phone for activities on the go.

It should be noted that a situation can also be defined based on the state (or status) of one or more usable components of the computing systems (e.g., one or more applications). In other words, the state of use of one more usable components (e.g., one or more designated applications) can also be considered in addition to other contextual variables (e.g., temperature) in defining a situation. As such, one or more usable components can be defined to be effectively a part of the context of use, for example, for one or more other usable components. By way of example, the state of use of a first group of applications can be used as context variables combined with other context variable (e.g., environmental variables) in order to define a situation for a second group of applications (i.e., a situation associated with state of use of the second group of applications.

Devices with sufficient computing, networking, and storage resources can be assigned to mine users' long-term, general, situation independent habits and interests. This can be achieved by various ways. One of them is to gather all the original log data and mining long-term patterns directly from them. Another is to gather the learning results as well as the log data for the analysis. The learned general long-term interests can then be used by the other devices. Based on the main functions of a device, the device will use the general long-term interests to better serve the user for its domain of service. For example, a TV may identify general interests in entertainment domain and use them for better recommendations. A robot in charged of helping a child to learn, may chose interest terms, map them into a context for education and find the most appropriate material for the child. A car may choose and use the interest information for entertainment, navigation, as well as recommendations.

When a user is in a situation where a query should be formed, such as when accessing a database or navigating to a search engine, the system then can aid in the formation of the query by examining the user's interests. It should be noted that the assistance provided by the system in this regard can vary greatly as to how much of the query is formed automatically. For example, in some systems or circumstances, the system may form the entire query automatically without input from the user. In other systems or circumstances, the system may only form part of the query or may attempt to complete the query as the user is typing it. For example, the user may type in the word “scores” and the system may, armed with the knowledge that the user is a baseball fan, add the term “baseball” to the query to return baseball scores (as opposed to, say basketball scores). Alternatively, the user may be typing the term “baseball” but the system may assume this fact after the user has only typed “bas” and may complete the term for him, saving the user from having to enter in more characters. Of course, the query completion or addition is still based, at least partially, on the derived interests of the user.

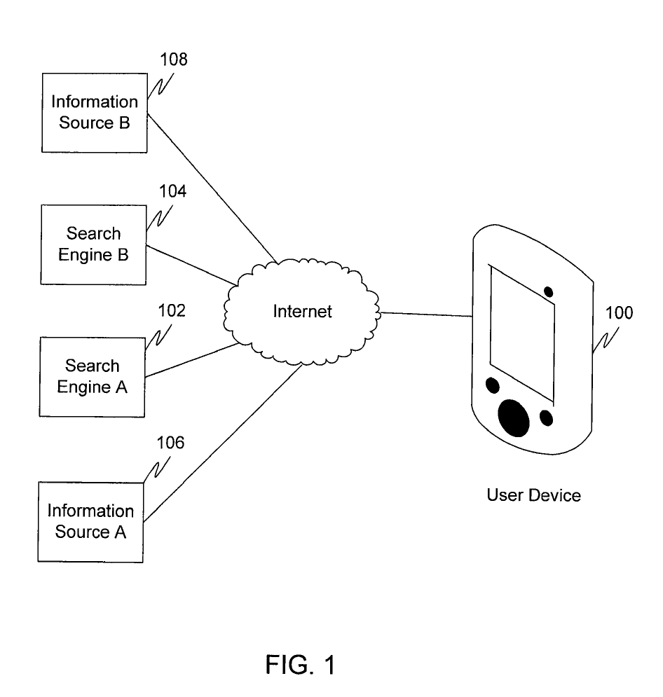

FIG. 1 is a diagram illustrating an overview of an embodiment of the present invention. In this embodiment, the user device 100 is a personal data assistant or cell phone through which the user accomplishes many operations, such as communication (e.g., phone calls, emails, chats, text messaging), information retrieval (e.g., web pages, RSS feeds, etc.) and others (e.g., photo capturing, sharing, etc.). The search engines 102, 104 are entities on the Internet that can accept a query and return related results. Other information sources 106, 108 are also accessed by the user device 100.

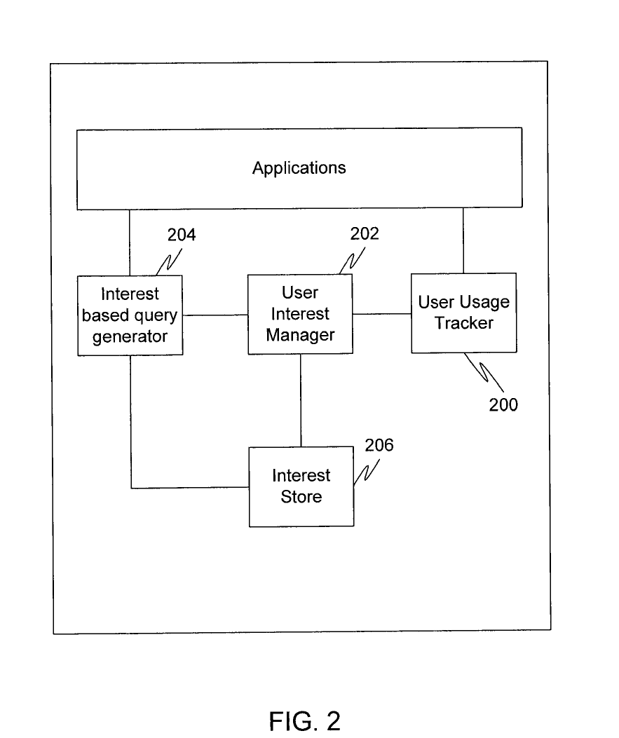

FIG. 2 is a diagram illustrating the architecture of an embodiment of the present invention. A user usage tracker 200 captures the user activity that can lead to capturing their interest and feeds the collected information to a user interest manager 202. The user interest manager 202 analyzes the captured information to deduce the user's interests. The interest based query generator 204 then gathers the appropriate interest information from the user interest manager 202 and generates or aids in the generation of a query using this information. The query may then be returned to the corresponding application. The application can then perform the query to gather the results.

It should be noted that in some embodiments the user may be presented with the query first prior to it being used to gather results. The user is then permitted to accept or reject the query. In other embodiments, however, the query is simply generated without user approval.

The operations that can indicate user interest, such as browsing web content, emails, RSS feeds, SMS messages, IM applications, etc. are monitored by the user usage tracker 200. The user interest manager 202 is responsible for deriving the user interest for different situations from the usage history provided by the tracker and identifying the interests in the current situations. The user interest manager also stores the user interest information in the interest store 206 and provides these interests to the Internet based query generator upon request. The user interest manager 202 may also utilize context information. Context refers to the situation in which the user and/or device the user is operating. For example, the context may include the location of the user—whether the user is home, at the office, or elsewhere. The context may also include the time of day—for example, whether it is morning, afternoon, or evening. One of ordinary skill in the art will recognize that there may be many other types of information captured by the context and nothing in this document shall be read as limiting the invention to any particular type of information.

When a request for interest keywords comes from the Interest based query generator, the user interest manager 202 computes the similarity between current context values with the context values in each situation stored in the interest store and uses the interests in the most similar situations or the interests in a top few similar situations as the user's current interests. The interest based query generator 204 can then select keywords from the interests to form or aid in forming a query. For example, query words can be selected based on the statistical rating values of the interest keywords. In addition, the generator can also add context information such as the location, time, etc. To augment the query.

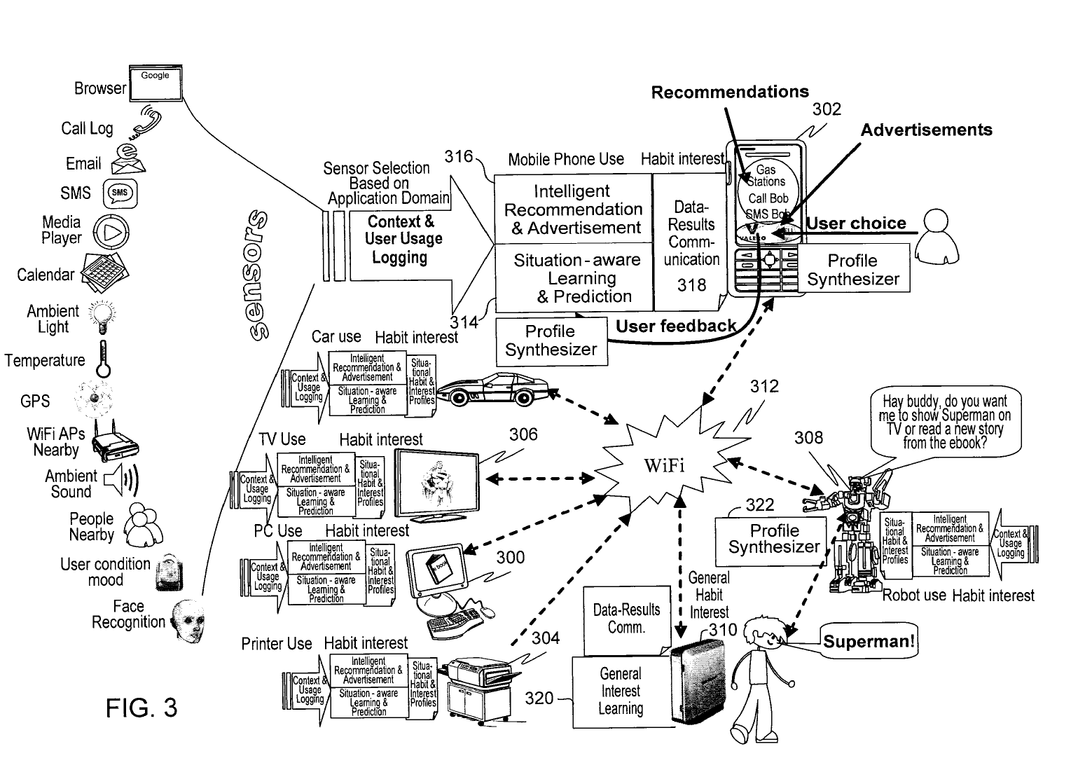

FIG. 3 shows an example of a distributed learning system on CE devices, examples of context collected via sensors, examples of software module distribution, and examples of use case scenarios. This system is used to collect usage information and derive interests, such as would be performed by user usage tracker 200 and user interest manager 202 of FIG. 2. As shown in the figure, the system contains a PC 300, a mobile phone 302, a printer 304, a digital TV/set top box 306, a robot 308, and a home server 310 connected via a home WiFi network 312.

The sensors can be implemented as pure software modules or hardware software combination. Examples of software-only sensors include sensors for Browser, phone calls, email, SMS, media player, calendar. Examples of hardware-software combined sensors include GPS, lighting, temperature, WiFi, sound, mood, people, and faces.

In this example, the PC 300, mobile phone 302, printer 304, digital TV/set top box 306, robot 308, and home server 310 each hosts a situation-aware learning and predication module 314, an intelligent recommendation and advertisement module (application) 316, and a data-results communication module 318. The home server 310 hosts a learning module 320 for general and situation-independent interests. The car, phone, and robot, each also hosts a profile synthesis module 322. If the user does not have a home server, the PC can host the general profile extraction module. Another variation is that the PC does not host situation-aware learning module. It should be noted that these are merely optional examples. The present invention is also capable of operating in a stand-alone mode, for example on a mobile phone.

Each of these devices can collect one or more contexts; all devices collect system time as a context from which day of a week and time of a day can typically be derived. Each device logs a usage event together with the context value(s) available to it. The log data is then used by the learning module to derive user interest patterns. Based on the special purpose(s) of a device the learned results from its own log data can be domain specific. For example, the pattern extracted by the TV captures user's TV viewing interests and the printer derives user's habits of printer usage. Since a user can view TV programs on a TV, or a phone, or an in-car screen, exchanging user's TV viewing interests learned among these devices and synthesize with locally learned interests can be used to enhance user's TV viewing experience.

The figure also shows an example of recommendations and advertisement made based on the learned user interest profile. When the user makes a selection, either from the recommended items, or from the advertisements, or from other sources, the event will be recorded in the log and will be used for future learning. In this way, the device automatically adapts to user's changing habits and interests. A similar example is shown for the robot where it tries to engage the child by giving him choices of activities. The choice of the child will also be used in the future learning processes.

In one embodiment, a database of keywords related to a user interest may be compiled, and this database may be references once an interest related to a user's current situation is identified. For example, if the user's interest is “baseball”, baseball related keywords may be stored in the database such as “bat, glove, ball, steal, home plate, pitch, batter, etc.).

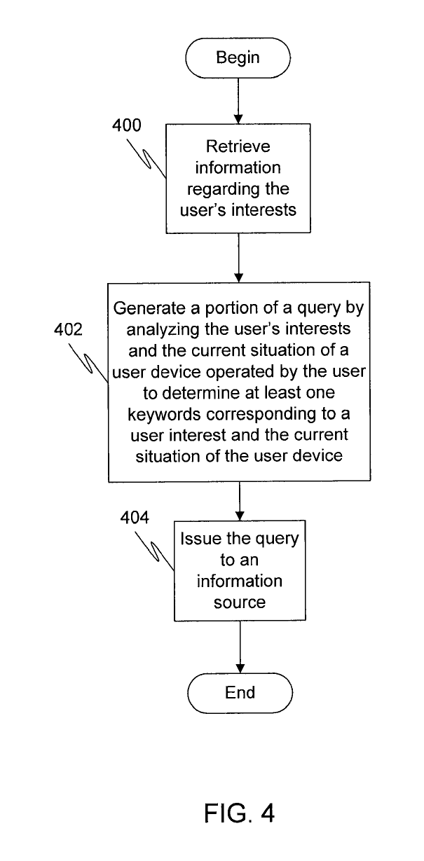

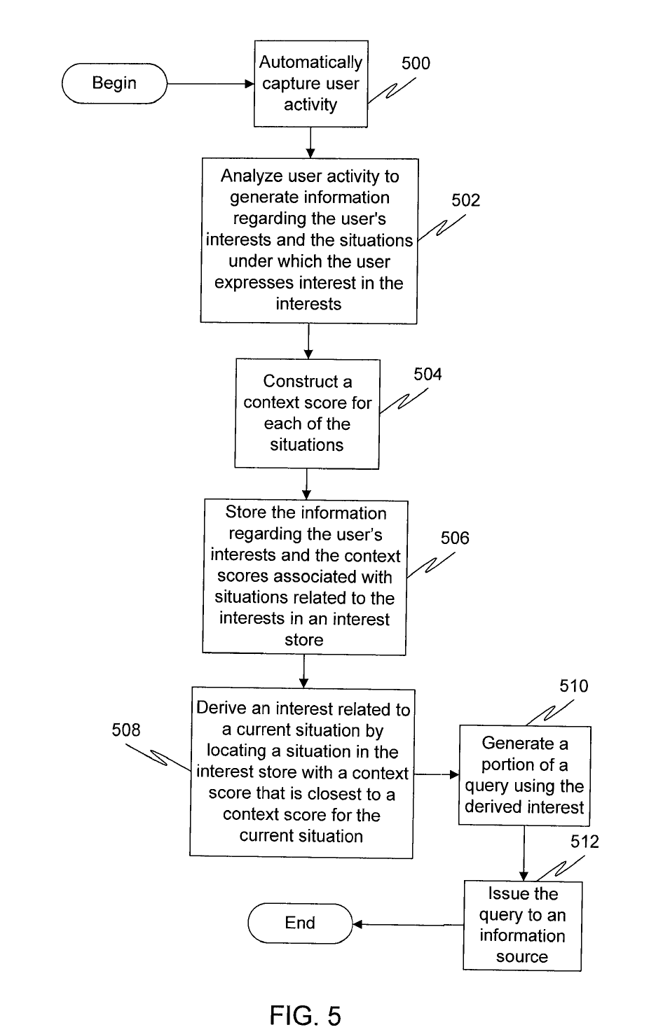

FIG. 4 is a flow diagram illustrating a method for generating a portion of a query for a user in accordance with an embodiment of the present invention. At 400, information is retrieved regarding the user's interests. This information may be retrieved from an interest store. In one embodiment of the present invention, the device performing the method of claim 4 does not perform the user activity capturing, formation of user interests, or storing of this information in an interest store. Such steps are left to the embodiment of FIG. 5, described in more detail below.

At 402, a portion of a query is generated by analyzing the user's interests and the current situation of a user device operated by the user to determine at least one keyword corresponding to a user interest and the current situation of the user device.

It should be noted that the phrase “portion of a query” shall be interpreted in this document as meaning any portion of a query, including possibly the entire query (100%). In other words, the term “portion” should not be limited to merely a “part” of a query but shall be interpreted to cover situations where the entire query is generated based on the interest.

At 404, the query is issued to an information source. It should be noted that this may be performed either with or without first presenting the query to the user for approval.

FIG. 5 is a flow diagram illustrating a method for generating a portion of a query for a user in accordance with another embodiment of the present invention. At 500, user activity is automatically captured. At 502, the user activity is analyzed to generate information regarding the user's interests and the situations under which the user expresses interest in the interests. At 504, a context score for each of the situations is constructed. At 506, the information regarding the user's interests and the context scores associated with situations related to the interests are stored in an interest store.

At 508, an interest related to a current situation is derived by locating a situation in the interest store with a context score that is closest to a context score for the current situation. At 510, a portion of a query is generated using the derived interest.

At 512, the query is issued to an information source. It should be noted that this may be performed either with or without first presenting the query to the user for approval.

Additionally, embodiments are foreseen wherein the Interest-based query formation mechanism can be applied to other information sources such as multimedia repositories (video, audio, photos, etc.), either individually or in a hybrid format. Many other applications can also be empowered through the present invention, such as an Interest-based home page selection for a user, interest based RSS feed presentations, etc.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for generating a portion of a query for a user, the method comprising:
retrieving information regarding the user's interests; and
generating a portion of a query by analyzing the user's interests and the current situation of a user device operated by the user to determine at least one keyword corresponding to a user interest and the current situation of the user device.

2. The method of claim 1, wherein the portion of the query is the entire query.

3. The method of claim 1, wherein the current situation includes one or more of the following: location of the user device, time of day, and applications running on the user device.

4. The method of claim 1, further comprising:
automatically capturing user activity; and
analyzing the user activity to generate information regarding the user's interests; and
storing the information regarding the user's interests in an interest store.

5. The method of claim 4, wherein the user activity includes browsing web content and composing email messages.

6. The method of claim 4, wherein the analyzing further comprises, for each user interest, analyzing the situation in which the user activity reflected the interest, and wherein the storing includes storing the situation in the interest store.

7. The method of claim 6, further comprising storing a context value for the situation.

8. The method of claim 7, wherein the generating includes identifying an interest corresponding to a situation having a context value that is closest to a current situation.

9. The method of claim 1, further comprising automatically issuing the query to an information source.

10. The method of claim 1, further comprising presenting the query to the user for approval prior to issuing the query to an information source.

11. A method for generating a portion of a query for a user, the method comprising:
automatically capturing user activity;
analyzing the user activity to generate information regarding the user's interests and the situations under which the user expresses interest in the interests;
constructing a context score for each of the situations;
storing the information regarding the user's interests and the context scores associated with situations related to the interests in an interest store;
deriving an interest related to a current situation by locating a situation in the interest store with a context score that is closest to a context score for the current situation; and
generating a portion of a query using the derived interest.

12. An apparatus comprising:
an interest store containing interests corresponding to a user and situations related to the interests;
an interest-based query generator coupled to the interest store and configured to:
retrieve information regarding user interests; and
generate a portion of a query by analyzing the user's interests and the current situation of a user device operated by the user to determine at least one keyword corresponding to a user interest and the current situation of the user device.

13. An apparatus comprising:
a user usage tracker configured to automatically capture user activity;
a user interest manager configured to analyze the user activity to generate information regarding the user's interests and the situations under which the user expresses interest in the interests, construct a context score for each of the situations, and storing the information regarding the user's interests and the context scores associated with situations related to the interests in an interest store; and
an interest-based query generator configured to derive an interest related to a current situation by locating a situation in the interest store with a context score that is closest to a context score for the current situation and generate a portion of a query using the derived interest.

14. A system for generating a portion of a query for a user, the system comprising:
means for retrieving information regarding the user's interests; and
means for generating a portion of a query by analyzing the user's interests and the current situation of a user device operated by the user to determine at least one keyword corresponding to a user interest and the current situation of the user device.

15. A system for generating a portion of a query for a user, the system comprising:
means for automatically capturing user activity;
means for analyzing the user activity to generate information regarding the user's interests and the situations under which the user expresses interest in the interests;
means for constructing a context score for each of the situations;
means for storing the information regarding the user's interests and the context scores associated with situations related to the interests in an interest store;
means for deriving an interest related to a current situation by locating a situation in the interest store with a context score that is closest to a context score for the current situation; and
means for generating a portion of a query using the derived interest.

16. A program storage device readable by a machine tangibly embodying a program of instructions executable by the machine to perform a method for generating a portion of a query for a user, the method comprising:
retrieving information regarding the user's interests; and
generating a portion of a query by analyzing the user's interests and the current situation of a user device operated by the user to determine at least one keyword corresponding to a user interest and the current situation of the user device.

17. A program storage device readable by a machine tangibly embodying a program of instructions executable by the machine to perform a method for generating a portion of a query for a user, the method comprising:
automatically capturing user activity;
analyzing the user activity to generate information regarding the user's interests and the situations under which the user expresses interest in the interests;
constructing a context score for each of the situations;
storing the information regarding the user's interests and the context scores associated with situations related to the interests in an interest store;
deriving an interest related to a current situation by locating a situation in the interest store with a context score that is closest to a context score for the current situation; and
generating a portion of a query using the derived interest.
